(19) United States
(12) Patent Application Publication
(10) Pub. No.: US 2023/0408693 A1
(43) Pub. Date: Dec. 21, 2023

(54) FMCW LIDAR SYSTEM

(71) Applicant: ams-OSRAM International GmbH, Regensburg (DE)

(72) Inventors: Martin Rudolf BEHRINGER, Regensburg (DE); Hubert HALBRITTER, Dietfurt-Toeging (DE); Stephan HANEDER, Wenzenbach (DE)

(21) Appl. No.: 18/250,361

(22) PCT Filed: Oct. 12, 2021
(86) PCT No.: PCT/EP2021/078168

§ 371 Date: Apr. 25, 2023

(30) Foreign Application Priority Data
Oct. 29, 2020 (DE) 10 2020 128 443.8

(51) Int. Cl. G01S 17/34; G01S 7/481; G01S 7/4912

(52) U.S. Cl. CPC G01S 17/34; G01S 17/931; G01S 7/4917; G01S 7/4815

(57) ABSTRACT

An FMCW LIDAR system includes a laser which emits a laser beam and a radiation source which comprises a frequency comb generator. The semiconductor laser may be a VCSEL. The frequency comb generator generates a frequency comb from the laser beam. A beam bundle comprising a plurality of laser beams, each of which has a respective wavelength of λ₁, λ₂, λ₃, . . . λₙ, or laser mode, is generated from the laser beam having a wavelength λ₀. The generated beam bundle is fed to a beam splitter which allows one part of each individual laser beam to pass in the direction of the object to be measured. Another part of each individual laser beam is allowed to pass as a reference beam in the direction of an assembly of detector elements. The system may further include a first grating and a second grating.

### CROSS-REFERENCE TO RELATED APPLICATIONS

The present application is a national stage entry according to 35 U.S.C. § 371 of PCT application No.: PCT/EP2021/078168 filed on Oct. 12, 2021; which claims priority to German patent application DE 10 2020 128 443.8, filed on Oct. 29, 2020; all of which are incorporated herein by reference in their entirety and for all purposes.

### TECHNICAL FIELD

A FMCW LIDAR system is specified, in particular a FMCW LIDAR system having a radiation source and a frequency comb generator to generate a frequency comb from an emitted laser beam.

### BACKGROUND

LIDAR (“Light Detection and Ranging”) systems, in particular FMCW (“Frequency Modulated Continuous Wave”) LIDAR systems are increasingly being used in vehicles, for example for autonomous driving. For example, they are used for measuring distances or for recognizing objects. In order to be able to reliably detect objects at greater distances, laser light sources of appropriately high power are required.

In general, efforts are being made to provide a large area radiation source for an FMCW LIDAR system.

It is an objective to provide an improved FMCW LIDAR system.

### SUMMARY

According to embodiments, the object is achieved by the claimed matter of the independent claims. Advantageous enhancements are defined in the dependent claims.

According to embodiments, an FMCW LIDAR system includes a radiation source which comprises a frequency comb generator.

The radiation source may further comprise a semiconductor laser which is adapted to emit a laser beam. The frequency comb generator is adapted to generate a frequency comb from the emitted laser beam.

The FMCW LIDAR system may further comprise a first grating which is adapted to deflect components of the frequency comb having different wavelengths into different spatial directions. The first grating is arranged between the frequency comb generator and an object to be measured.

The FMCW LIDAR system may further comprise an array of detector elements. The array of detector elements is adapted to detect a mixed signal which is generated on the basis of a reflected beam reflected by an object to be measured and a reference beam.

The FMCW-LIDAR system may further comprise a second grating which is adapted to deflect electromagnetic radiation incident on the second grating onto different detector elements as a function of the wavelength of the electromagnetic radiation.

According to embodiments, the second grating may be adapted to deflect a reflected beam associated with a reference beam and the reference beam onto a common detector element.

According to further embodiments, the second grating may be arranged at a position where the beam reflected by the object to be measured is split and is superimposed with the reference beam after splitting.

The radiation source may further comprise a modulation device for modulating a wavelength emitted by the radiation source. For example, the modulation device may comprise a voltage source that is adapted to modify a current intensity impressed into the semiconductor laser.

For example, the frequency comb generator may comprise a microresonator.

For example, the frequency comb generator may be adapted to set a mode spacing greater than 5 GHz between adjacent modes.

According to embodiments, the radiation source may be realized in a photonic chip. For example, the frequency comb generator may further be integrated with the photonic chip.

For example, the semiconductor laser may be a vertical cavity surface emitting laser (VCSEL).

According to a further embodiment, a radiation source is provided which comprises a semiconductor laser and a frequency comb generator. The semiconductor laser is adapted to emit a laser beam, and the frequency comb generator is adapted to generate a frequency comb from the emitted laser beam.

For example, the semiconductor laser may be a vertical cavity surface emitting laser (VCSEL).

### BRIEF DESCRIPTION OF THE DRAWINGS

The accompanying drawings serve to provide an understanding of non-limiting embodiments. The drawings illustrate embodiments and, together with the description, serve for explanation thereof. Further example embodiments and many of the intended effects will become apparent directly from the following detailed description. The elements and structures shown in the drawings are not necessarily shown to scale relative to each other. Like reference numerals refer to like or corresponding elements and structures.

FIG. 1A shows a schematic representation of an FMCW LIDAR system according to embodiments.

FIG. 1B schematically illustrates a laser beam and a frequency comb generated from the laser beam.

FIG. 2A shows a schematic plan view of a radiation source of an FMCW LIDAR system.

FIG. 2B shows a schematic perspective view of a photonic chip in which components of the FMCW LIDAR system are realized.

### DETAILED DESCRIPTION

In the following detailed description, reference is made to the accompanying drawings, which form a part of the disclosure and in which specific exemplary embodiments are shown for purposes of illustration. In this context, directional terminology such as “top”, “bottom”, “front”, “back”, “over”, “on”, “in front”, “behind”, “leading”, “trailing”, etc. refers to the orientation of the figures just described. As the components of the embodiments may be positioned in different orientations, the directional terminology is used by way of explanation only and is in no way intended to be limiting.

The description of the embodiments is not limiting, since other embodiments may also exist and structural or logical changes may be made without departing from the scope as defined by the patent claims. In particular, elements of the embodiments described below may be combined with elements from others of the embodiments described, unless the context indicates otherwise.

The term “vertical” as used in this description is intended to describe an orientation which is essentially perpendicular to the first surface of a substrate or a semiconductor body. The vertical direction may correspond, for example, to a direction of growth when layers are grown.

The terms “lateral” and “horizontal”, as used in the present description, are intended to describe an orientation or alignment which extends essentially parallel to a first surface of a substrate or a semiconductor body. This may be the surface of a wafer or a chip (die), for example.

The horizontal direction may, for example, be in a plane perpendicular to a direction of growth when layers are grown.

As used herein, the terms “have”, “include”, “comprise”, and the like are open-ended terms that indicate the presence of said elements or features, but do not exclude the presence of further elements or features. Indefinite articles and definite articles include both the plural and the singular, unless the context clearly indicates otherwise.

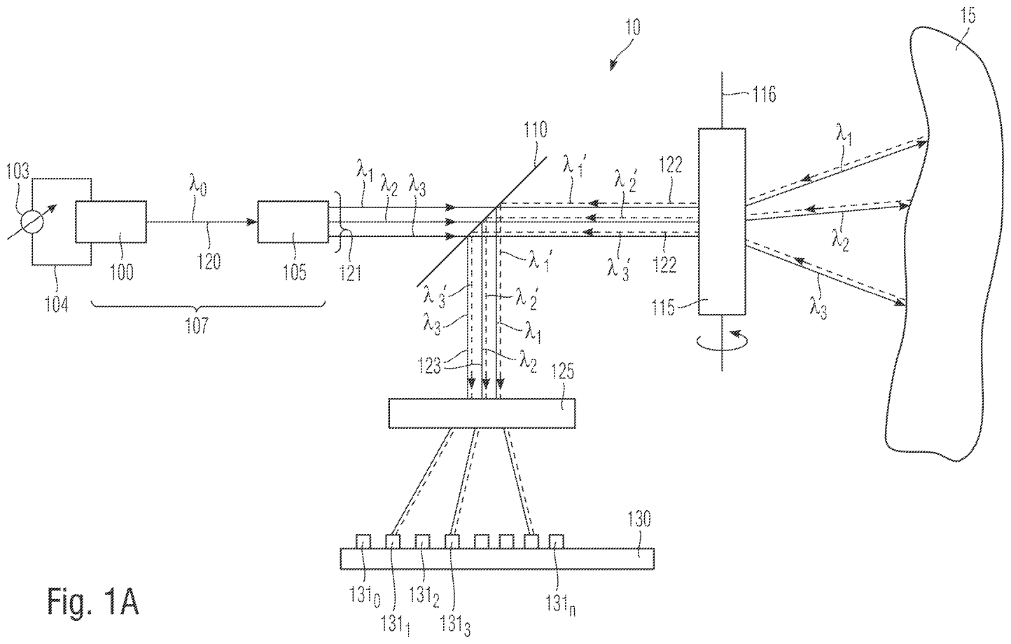

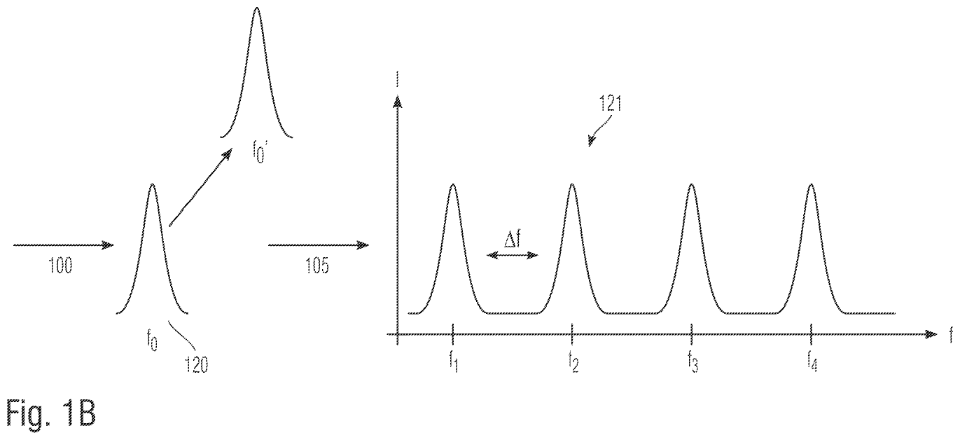

FIG. 1 shows a schematic view of an FMCW LIDAR system 10 according to embodiments. The FMCW LIDAR system shown in FIG. 1 includes a radiation source 107 which comprises a frequency comb generator 105. The radiation source 107 may further comprise a laser that emits a laser beam 120. For example, the laser may be a semiconductor laser 100. The semiconductor laser 100 may, for example, be an edge-emitting laser or also a surface-emitting laser, for example a VCSEL (“Vertical Cavity Surface Emitting Laser”).

The laser beam 120 emitted by the laser, for example the semiconductor laser 100, is fed to a frequency comb generator 105, which generates a frequency comb 121 from the laser beam 120. More precisely, a bundle of beams comprising a plurality of laser beams, each of different wavelengths λ₁, λ₂, λ₃, . . . λₙ or laser modes is generated from a laser beam 120 of a wavelength λ₀. That is, a multiplication into the wavelength space takes place. The bundle of beams generated is fed, for example, to a beam splitter 110 which transmits a portion of each of the individual laser beams in the direction of the object 15 to be measured. Another portion of each of the individual laser beams is transmitted in the direction of an array 130 of detector elements 131ᵢ as a reference beam 123.

The FMCW LIDAR system further comprises a first grating 115 which is adapted to deflect the individual laser beams of the frequency comb 121 into different spatial directions according to their respective wavelengths. For example, the frequency comb may comprise the wavelengths λ₁, λ₂, λ₃. The individual laser beams are deflected by the first grating 115 at different deflection angles, respectively, so that an object 15 to be measured is irradiated with the individual beams of the frequency comb 121. Different laser beams, each of different wavelengths, are radiated onto different parts of the object. Therefore, a conversion of the multiplication in the wavelength space into a multiplication in the vector space takes place.

The incident laser radiation is reflected at the object 15. The reflected beams 122 are in turn fed to the beam splitter 110 via the first grating 115 and deflected in the direction of the detector array 130.

The FMCW LIDAR system 10 further comprises a demultiplexer or a second grating 125 which, in a manner similar to the first grating 115, is adapted to deflect the laser beams of different wavelengths at different deflection angles. As a result, laser beams of similar wavelengths are deflected into similar solid angle ranges and arrive at a corresponding detector element 131ᵢ of array 130.

For example, the second grating 125 may be arranged in a position such that both the beams 122 reflected by the object and the reference beams 123 are deflected according to their wavelengths.

What is achieved in this way is that a beam 122 reflected by the object 15 and belonging to an n-th mode of the frequency comb is deflected together with the n-th mode of the reference beam 123 onto a common detector element 131ₙ.

A mixing of the reference beam 123, which has been directed in the direction of the detector 130 directly by the beam splitter 110, and the laser beam 122, which has been reflected by the object 15, takes place at the respective detector element 131ₙ. The individual detector elements 131ᵢ of the array 130 are thus adapted to determine a mixed or beat signal from these beams.

The mixed signal may be represented as follows:

i_{sig}=iₐ+i_{LO}+2\sqrt{iₐi_{LO}}cos[2π(fₐ−f_{LO})t+(φₐ−φ_{LO})] (1)

Herein, i_{sig} denotes an intensity of the mixed signal, iₐ denotes an intensity of the signal reflected by the object 15, and i_{LO} denotes an intensity of the reference signal 123. fₐ denotes a frequency of the signal reflected by the object 15, and f_{LO} denotes a frequency of the reference signal. φₐ−φ_{LO} denotes a phase difference of the signal reflected by the object and the reference signal. The detector elements 131ᵢ are adapted to detect a periodic signal the frequency of which corresponds to the difference between fₐ and f_{LO}. The frequency fₐ of the reflected beam is delayed compared to the frequency f_{LO} of the reference beam due to the runtime difference that occurs when it is reflected at the object. The difference between fₐ and f_{LO} is thus a measure of the movement and distance of the object 15.

According to configurations, the detector elements 131ᵢ may form what is known as a “balanced receiver structure”. In this case, for example, the phase fronts between the photodetectors may be shifted by 180°. In this manner, for example, DC components may be eliminated from equation (1) described above. In particular, the term (iₐ+i_{LO}) may be eliminated from equation (1).

A frequency of the laser beam 120 emitted by the laser source 100 is usually varied over time. In a corresponding manner, a frequency of the partial beams of the frequency comb 121 is also modulated over time. The frequency-shifted reference beam and the laser beam reflected by the object 15 are superimposed at the individual detector elements. Here, a frequency of the mixed signal is a measure of the distance or the speed of the object 15.

As the mixing of the reflected signal with the non-reflected signal occurs only in the individual detector elements, it is possible to achieve a splitting of the individual laser beams according to wavelength by using the second grating 125. As a result, the matching laser beams are superimposed on each other.

The individual detector elements 131 may each be designed as semiconductor detectors, for example as photodetectors, for example photodiodes or photomixers. As a result, the signal from the different detector elements 131₀, . . . , 131ₙ provides information about the distance and speed of objects located at the respective solid angles of the original vectors. In this manner, it is possible to measure a one-dimensional object 15 using a single laser beam 120.

According to embodiments, the first grating 115 may be rotatable about an axis 116. For example, the first grating 115 may be arranged on a mechanically rotatable element, for example a microsystem or MEMS (“microelectromechanical system”). In this manner, a two-dimensional object may be measured.

Accordingly, according to embodiments, an object may be measured in terms of area using a single laser beam 120 and a frequency comb generator 105. As a result, it is possible to realize the FMCW LIDAR system at low cost and compact size. Furthermore, a higher resolution is achieved than with conventional systems.

As has been described, the laser may be embodied as a semiconductor laser. For example, a modulation device 104 may be provided which is configured to modify a wavelength emitted by the semiconductor laser. For example, the modulation device 104 may comprise a voltage source 103. An emission wavelength may be modified by modifying the voltage applied to the laser device 100 and thus the current intensity impressed.

A current is impressed into the semiconductor laser by the voltage source 103. A small modification in the impressed current, for example in the range of a few μA, may change the wavelength in such a way that the frequency differences of the emitted radiation are in the MHz to GHz range. Due to the modulation of the current impressed, a modulation of the charge carrier density results, which leads to a change in the refractive index in the optical resonator. As a result, the wavelength is shifted. Furthermore, an increased charge carrier density causes an increase in temperature, which also leads to a change in the emission frequency. Accordingly, the emission frequency may be modulated within the MHz to GHz range.

For example, the maximum change in the emission frequency may be smaller than the distance between adjacent modes on the frequency comb. This is illustrated, for example, in FIG. 1B.

FIG. 1B schematically shows a frequency comb having a plurality of modes, each of which is spaced at an equal distance from one another (Δf). A maximum difference Δf′₀−Δf₀ of the emission frequency of the semiconductor laser due to the modulation of the emission frequency is smaller than the frequency difference Δf between adjacent modes of the frequency comb 121.

For example, at a modulation depth of the frequency modulation of the semiconductor laser 100 of approximately 500 MHz, the mode spacing within the frequency comb may be significantly greater than 500 MHz. Furthermore, the frequency comb generator may be selected such that the individual modes are easily separated, for example via a multiplexer that is designed as an arrayed waveguide grating or line waveguide grating. For example, the mode spacing may be greater than 5 GHz, for example 50 to 100 GHz.

According to further embodiments, the second grating 125 may be arranged at a position such that only the reflected beams 122 are deflected by the second grating 125 and are superimposed with the reference signal 123 after splitting. In this case, for example, at a mode spacing greater than 5 GHz when using a band-limited detector, mixing may only take place with the components of the reference beam 123 that have a frequency spacing of less than 1 GHz. In this manner, unambiguous assignment of angles may take place, although the second grating 125 does not split the reference beam 123.

According to further embodiments, the second grating 125 may be arranged at a position at which only the reference beam 123 but not the reflected signal is split. More specifically, the reflected signal is superimposed on the reference beam 123 after splitting.

In general, the second grating 125 may be dimensioned such that—depending on the frequency difference within the frequency comb—the individual laser modes may be sufficiently separated from one another. For example, properties of the first and second gratings 125 are determined by taking into account the mode spacing within the frequency comb 121. Furthermore, the distances between the individual detector elements 131ᵢ may be determined as a function of a grating constant of the second grating 125, the distance between the individual laser modes in the frequency comb, and the distance between the detector array 130 and the second grating 125. As a result, each partial beam of the frequency comb is directed onto a detector element together with the associated beam reflected by the object 15.

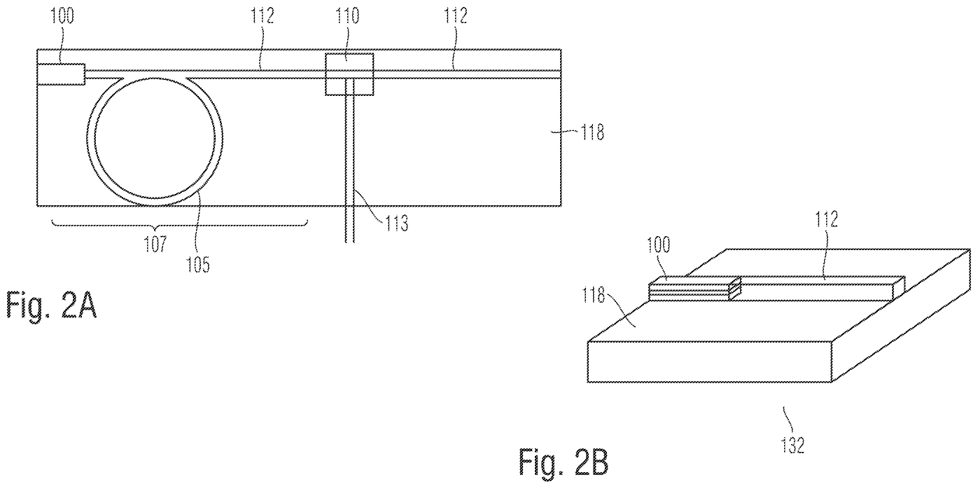

FIG. 2A shows an example of an implementation of a radiation source 107. As described, the radiation source 107 may comprise a semiconductor laser 100 and a frequency comb generator 105. As shown in FIG. 2A, the frequency comb generator 105 may be implemented as a microresonator, for example. For example, the microresonator may be part of a Si₃N₄ waveguide or a waveguide made of another material, for example Si, ZnSe, ZnO, InSnO, SiO₂ or a polymer. For example, the radiation source may also be connected to a waveguide 112, for example made of Si₃N₄ or SiO₂. Furthermore, for example, the beam splitter 110 may be implemented as a photonic component. Accordingly, the components of the FMCW LIDAR system may be arranged on a suitable substrate 118, for example a silicon substrate. For example, starting from the beam splitter 110, the portion of the frequency comb that is directed to the object may be routed via the first waveguide 112. Furthermore, starting from the beam splitter 110, that portion of the laser radiation which is supplied to the detector array 130 may be routed via a second waveguide 113.

FIG. 2B shows a perspective view of the semiconductor laser 100 and the waveguide 112. For example, the semiconductor laser 100 and the waveguide 112 may be formed as protruding structures over the substrate 118.

Accordingly, it is possible to form the components of the FMCW LIDAR system as a photonic chip. For example, the radiation source may be formed as a photonic chip. According to embodiments, additional further components of the FMCW-LIDAR system may be formed as photonic chip components and may be integrated with the radiation source on a common chip. According to embodiments, the radiation source and the frequency comb generator may be integrated into a photonic chip. For example, the gratings may also be formed as photonic chip components. The FMCW LIDAR system may thus be manufactured at a compact size and at low cost.

According to further embodiments, the laser radiation emitted by the semiconductor laser 100 may alternatively be modulated by an external frequency modulator. According to further embodiments, it is also possible to effect a shift of the wavelength by means of amplitude modulation within the frequency comb generator 105. According to embodiments, the microresonator may be designed in such a way, for example, that a modification in the intensity of the laser radiation passing through causes a shift in the individual laser modes in the microresonator.

Although specific embodiments have been illustrated and described herein, those skilled in the art will recognize that the specific embodiments shown and described may be replaced by a multiplicity of alternative and/or equivalent configurations without departing from the scope of the invention. The application is intended to cover any adaptations or variations of the specific embodiments discussed herein. Therefore, the invention is to be limited by the claims and their equivalents only.

### LIST OF REFERENCES

10 LIDAR system
15 object
100 laser source
103 voltage source
104 modulation device
105 frequency comb generator
107 radiation source
110 beam splitter
112 first optical waveguide
113 second optical waveguide
115 first grating
118 substrate
120 emitted laser beam
121 frequency comb
122 reflected beam
123 reference beam
125 second grating
130 array of detector elements
131₀, . . . 131ₙ detector element
132 photonic chip

1. A FMCW LIDAR system comprising:
a radiation source comprising a surface emitting semiconductor laser configured to emit a laser beam, wherein the radiation source is realized in a photonic chip; and
a frequency comb generator configured to generate a frequency comb from the emitted laser beam.

2. (canceled)

3. The FMCW LIDAR system according to claim 1, further comprising a first grating configured to deflect components of the frequency comb having different wavelengths into different spatial directions, the first grating being arranged between the frequency comb generator and an object to be measured.

4. The FMCW LIDAR system according to claim 1, further comprising an array of detector elements configured to detect a mixed signal generated on the basis of a reflected beam reflected by an object to be measured and a reference beam.

5. The FMCW LIDAR system according to claim 4, further comprising a second grating configured to deflect electromagnetic radiation incident on the second grating onto different detector elements as a function of the wavelength of the electromagnetic radiation.

6. The FMCW LIDAR system according to claim 5, wherein the second grating is further configured to deflect a reflected beam associated with a refence beam and the reference beam onto a common detector element.

7. The FMCW LIDAR system according to claim 5, wherein the second grating is arranged at a position where the beam reflected by the object to be measured is split and is superimposed with the reference beam after splitting.

8. The FMCW LIDAR system according to claim 1, wherein the radiation source further comprises a modulation device for modulating a wavelength emitted by the radiation source.

9. The FMCW LIDAR system according to claim 8, wherein the modulation device comprises a voltage source configured to modify a current intensity impressed into the surface emitting semiconductor laser.

10. The FMCW LIDAR system according to claim 1, wherein the frequency comb generator comprises a microresonator.

11. FMCW LIDAR system according to claim 1, wherein the frequency comb generator is configured to set a mode spacing greater than 5 GHz between adjacent modes.

12. (canceled)

13. The FMCW LIDAR system according to claim 1, wherein the frequency comb generator is integrated with the photonic chip.

14. The FMCW LIDAR system according to claim 1, wherein the surface emitting semiconductor laser is a vertical cavity surface-emitting laser (VCSEL).

15. A radiation source comprising a surface emitting semiconductor laser and a frequency comb generator,
wherein the surface emitting semiconductor laser is configured to emit a laser beam and the frequency comb generator is configured to generate a frequency comb from the emitted laser beam,
wherein the radiation source is implemented in a photonic chip.

16. The radiation source according to claim 15, wherein the surface emitting semiconductor laser is a vertical cavity surface-emitting laser (VCSEL).
